(19) United States
(12) Patent Application Publication
(10) Pub. No.: US 2025/0207060 A1
(43) Pub. Date: Jun. 26, 2025

(54) CONCENTRATED SILICONE ANTIFOAM EMULSION

(71) Applicant: ELKEM SILICONES FRANCE SAS, SAINT-FONS (FR)

(72) Inventors: Frédéric MARCHAL, L'Arbresle (FR); Eliane EMOND, Lyon (FR); Thierry WALTER, Fontaines sur Saone (FR)

(21) Appl. No.: 18/848,901

(22) PCT Filed: Mar. 20, 2023
(86) PCT No.: PCT/FR2023/000027

§ 371 Date: Sep. 19, 2024

(30) Foreign Application Priority Data
Mar. 21, 2022 (FR) FR2202457

(51) Int. Cl. C11D 3/00; C11D 3/37; C11D 11/00; C11D 17/00

(52) U.S. Cl. CPC C11D 3/0026; C11D 3/373; C11D 11/0094; C11D 17/0021

(57) ABSTRACT

A concentrated silicone-in-water antifoam emulsion and a preparation process and a process for inhibiting foam are described herein.

### TECHNICAL FIELD

The present invention relates to the field of silicone antifoams. More specifically, the invention relates to a concentrated silicone-in-water antifoam emulsion, which is handleable, dispersible, storage stable and effective. The present invention also relates to a process for preparing this non-viscous concentrated antifoam emulsion and to a process for inhibiting foam formation using this concentrated antifoam emulsion.

### TECHNOLOGICAL BACKGROUND

Foams are dispersions of gas bubbles in liquids or solid matrices. Surfactants or surface agents such as detergents, wetting agents, emulsifiers or dispersants, which are commonly used in various industries, reduce the surface tension of a liquid and due to their amphiphilic nature tend to accumulate at the air-liquid interfaces, slowing down the coalescence of the gas bubbles and consequently stabilizing the foam.

Antifoam compositions are systems which, when added to the foaming liquid, accelerate the collapse of the foam relative to the formation of the foam. Usually, these compositions are added at low concentrations. Antifoams have found an application in a large variety of production and treatment processes, for example paints and latices, coating processes, textiles, fermentation processes, polymer production, cleaning compounds, pulp and paper, wastewater treatment and cooling towers.

The addition of a silicone antifoam composition has proved particularly effective for controlling the foam. Silicone antifoam compositions are dispersions of hydrophobic particles such as silica in a silicone matrix. U.S. Pat. No. 3,383,327 describes a composition comprising a silica dispersed and heated in a polydimethylsiloxane.

In order to obtain improved antifoam performance, the polydimethylsiloxane can be partially replaced by a branched polymer or three-dimensional network.

For this purpose, EP 0163541 describes a process for preparing a silicone antifoam by polycondensation reaction at temperature using a reactive organopolysiloxane containing hydroxyl or alkoxy groups in the presence of a catalyst, silicone resin, a filler and non-reactive organopolysiloxanes. Furthermore, EP 2794760 describes a process for preparing, at temperature, a silicone antifoam from a mixture of a reactive organopolysiloxane containing hydroxyl groups, two silicas, which are respectively hydrophobic and hydrophilic, and a silicone resin, in the presence of catalyst. Here too a polycondensation reaction is used. Documents EP 0434060, U.S. Pat. No. 8,053,480 and WO 2021/167728 describe silicone antifoams obtained from polyaddition chemistry. Patent applications WO 2020/108750 and WO 2020/108751 combine polyaddition and polycondensation chemistry. Irradiation chemistry using high-energy radiation is also described in WO 2021/126195.

However, these silicone antifoams may be viscous, which does not favor their use and they are not readily dispersible in an aqueous medium. Furthermore, they sometimes exhibit viscoelastic behavior, also known as the Weissenberg effect. Said effect is a manifestation of a difference in normal non-zero stresses typical of certain polymer solutions (viscoelastic fluids). The phenomenon is manifested by the liquid climbing up a spinning rod immersed in such a viscoelastic fluid. This is why they are formulated as silicone-in-water emulsions by means of the addition of emulsifiers.

Various compositions are described for obtaining silicone antifoam emulsions. For example, WO 2016/107987 describes a method for preparing silicone droplets in water with a silicone content limited to 10% by weight. Higher concentrations are described in WO 1998/000216 in which examples consist of emulsions containing 35% solids. The emulsifying of silicone antifoams often requires the use of specific surfactants such as the sorbitan esters cited in WO 1998/000216 and WO 2016/107987 which prevents the silicone antifoam from breaking the interfacial layer of the emulsion.

For productivity and eco-design reasons, it is increasingly desired to limit the concentration of water and therefore to increase the concentration of silicone in the silicone antifoam emulsions. However, it is well known in the field of emulsions that an increase in the volume fraction of droplets greatly increases the viscosity. By increasing the concentration, the emulsions change from Newtonian behavior to non-Newtonian pseudoplastic behavior and become very difficult to handle, pour, pump and disperse.

In this context, there is a need firstly for an emulsion of a silicone antifoam with a high viscosity or a viscoelastic character, with a high concentration of silicone while maintaining low emulsion viscosities typically of less than 6000 mPa·s, preferentially less than 3500 mPa·s, and having a good storage stability, and secondly for these emulsions to be water-dispersible in order to ensure the availability of the active portion at the liquid-gas interfaces, meaning that the antifoam performance must not be impacted by the species used for the emulsifying.

In this context, the present invention aims to satisfy at least one of the following objectives.

One objective of the present invention is to provide a silicone antifoam emulsion that simultaneously meets these needs, namely high concentration of silicone while retaining a low viscosity, dispersible, storage stable and that has good antifoaming properties.

Another essential objective of the invention is to provide a process for preparing a silicone antifoam emulsion, said emulsion obtained simultaneously meeting these needs, namely high concentration of silicone while retaining a low viscosity, dispersible, storage stable and having good antifoaming properties.

Another essential objective of the invention is to provide a process for inhibiting foam formation using a concentrated low-viscosity silicone antifoam emulsion which is dispersible, storage stable and has good antifoaming properties.

### SUMMARY OF THE INVENTION

These objectives, among others, are achieved by the present invention which relates firstly to a silicone-in-water antifoam emulsion EA comprising:
at least a first silicone-in-water antifoam emulsion EA1 with a volume mean diameter d_{EA1} of greater than or equal to 6 μm comprising:
a) at least one silicone antifoam AS comprising from 0.1% to 10% by weight of at least one mineral filler C,
b) optionally at least one organopolysiloxane B1,
c) at least one emulsifier D1,
d) at least one additive F1,
e) water W1, and
   at least a second silicone-in-water emulsion E2 with a volume mean diameter d_{E2} of less than d_{EA1} and characterized in that the silicone-in-water antifoam emulsion EA comprises a water content of less than 65% by weight, preferably less than 60% by weight and preferentially less than 55% by weight.

The invention also relates to a process for preparing a silicone-in-water antifoam emulsion EA, characterized in that it comprises the following essential steps:
a) dispersing, with stirring and at a temperature above 50° C. and below 75° C., at least one silicone antifoam AS, optionally at least one organopolysiloxane B1, at least one emulsifier D1 and a portion of the water, until the mixture has been homogenized,
b) cooling, with stirring, the mixture obtained at the end of step a) down to a temperature below or equal to 30° C. and adding the second portion of water, then the additive F1 and stirring until the mixture has been homogenized in order to obtain EA1,
c) adding, to EA1, the silicone-in-water emulsion E2 and stirring until the antifoam emulsion EA has been completely homogenized.

The invention also relates to a process for inhibiting foam formation by adding an antifoam emulsion EA, to the liquid surface.

### DETAILED DESCRIPTION

The silicone-in-water antifoam emulsion EA comprising:
at least a first silicone-in-water antifoam emulsion EA1 with a volume mean diameter d_{EA1} of greater than or equal to 6 μm comprising:
a) at least one silicone antifoam AS comprising from 0.1% to 10% by weight of at least one mineral filler C,
b) optionally at least one organopolysiloxane B1,
c) at least one emulsifier D1,
d) at least one additive F1,
e) water W1, and
   at least a second silicone-in-water emulsion E2 with a volume mean diameter d_{E2} of less than d_{EA1} and characterized in that the silicone-in-water antifoam emulsion EA comprises a water content of less than 65% by weight, preferably less than 60% by weight and preferentially less than 55% by weight.

The silicone-in-water antifoam emulsion EA is characterized in that it has a viscosity of less than 6000 mPa·s and preferably of less than 3500 mPa·s.

All the viscosities referred to in the present disclosure correspond to a magnitude of dynamic viscosity at 25° C. termed “Newtonian”, i.e. the dynamic viscosity which is measured, in a manner known per se, with a Brookfield viscometer, at a shear rate gradient which is low enough for the viscosity measured to be independent of the shear rate gradient.

According to another embodiment, the silicone-in-water antifoam emulsion EA is characterized in that the content of silicone-in-water emulsion E2 is between 2% and 30% relative to the total weight of the silicone-in-water antifoam emulsion EA, preferably between 2.5% and 30% relative to the total weight of the silicone-in-water antifoam emulsion EA, more preferentially between 4% and 24% and even more preferentially between 6% and 20%.

According to another embodiment, the silicone-in-water antifoam emulsion EA is characterized in that the silicone-in-water emulsion E2 is an emulsion with a volume mean diameter d_{E2} of between 0.01 and 6 μm.

The mean size of the particles is measured by laser particle size analysis. The mean size the particles corresponds to the diameter D[4,3] which is the volume mean diameter. The definition of the volume mean diameter, D[4,3], is well known to those skilled in the art.

According to another embodiment, the silicone-in-water antifoam emulsion EA is characterized in that the silicone-in-water emulsion E2 is a silicone-in-water emulsion with a silicone concentration of greater than 35% by weight of the total weight of E2.

According to another preferred embodiment, the silicone-in-water antifoam emulsion EA is characterized in that the silicone-in-water emulsion E2 comprises
from 35 to 80 parts by weight of at least one organopolysiloxane B2,
from 0.1 to 10 parts by weight of at least one emulsifier D2,
from 0 to 5 parts by weight of at least one additive F2 and
from 5 to 65 parts by weight of water W2 per 100 parts by weight of the sum of the constituents B2, D2, F2 and W2.

The volume mean diameter D[4,3] of the emulsion EA1 is preferably greater than 6 μm, preferably between 7 and 150 μm and preferentially between 10 and 120 μm.

The fact of adding, to a silicone-in-water antifoam emulsion EA1 with a volume mean diameter d_{EA1} of greater than 6 μm, a silicone-in-water emulsion E2 with a volume mean diameter d_{E2} of less than d_{EA1} makes it possible to simultaneously obtain an emulsion that is concentrated in silicone and has a low viscosity. Hence, a productivity saving is obtained, the handling operations and transportation are thereby facilitated, while retaining good antifoaming properties.

The silicone-in-water antifoam emulsion EA according to the invention simultaneously has a silicone content of greater than 35%, a viscosity of less than 6000 mPa·s, preferably less than 3500 mPa·s, good water dispersibility, good storage stability and good antifoaming properties.

The silicone emulsion E2 is a silicone-in-water emulsion based on organopolysiloxanes.

To describe organopolysiloxanes, reference is made to siloxyl units M, D, T and Q. The letter M represents the monofunctional unit of formula (R)₃SiO_{1/2}, the silicone atom being bonded to a single oxygen atom in the polymer comprising this unit. The letter D signifies a difunctional unit (R)₂SiO_{2/2} in which the silicon atom is bonded to two oxygen atoms. The letter T represents a trifunctional unit of formula (R)SiO_{3/2}, in which the silicon atom is bonded to three oxygen atoms. The letter Q represents a tetrafunctional unit of formula SiO_{4/2}, in which the silicon atom is bonded to four oxygen atoms. The symbol R has the same definition as the symbols R², R³ and R⁴ defined below. The units M, D and T may be functionalized. Reference is then made to units M, D and T while specifying the specific radicals.

The silicone-in-water emulsion E2 comprises at least one organopolysiloxane B2, which may be chosen from the group consisting of:
non-reactive organopolysiloxanes which, per molecule, have monovalent organic substituents, which may be identical to or different from one another, bonded to the silicone atoms, and which are chosen from the group consisting of C₁-C₄₀ alkyl, C₃-C₈ cycloalkyl, C₆-C₁₀ aryl and C₇-C₅₀ alkylaryl radicals;
reactive organopolysiloxanes comprising at least two ≡SiOH silanol groups per molecule;
and mixtures thereof.

In the context of the invention, the term “non-reactive” is understood to mean an organopolysiloxane which, under the conditions of emulsification, of preparation of the silicone-in-water emulsion and of use, does not react chemically with any of the constituents of the emulsion.

The non-reactive organopolysiloxane may be an oil or a gum, and preferably has a dynamic viscosity of between 50 and 600 000 mPa·s at 25° C. or a consistency between 200 and 2000 expressed in tenths of a millimeter at 25° C.

The dynamic viscosity of silicones is measured at 25° C. according to the standard ASTM D 445.

The term “gum” is used for organopolysiloxane compounds having viscosities conventionally greater than ˜600 000 mPa·s, which corresponds to a molecular weight of greater than 260 000 g/mol.

The consistency or penetrability of a gum is determined at 25° C. by means of a penetrometer of PNR12 type or equivalent model allowing a cylindrical head to be applied to the sample under standardized conditions.

The penetrability of a gum is the depth, expressed in tenths of a millimeter, to which a calibrated cylinder penetrates the sample over one minute.

For this purpose, a sample of gum is introduced into an aluminum cup 40 mm in diameter and 60 mm tall. The bronze or brass cylindrical head is 6.35 mm in diameter and 4.76 mm long and is borne by a metal rod 51 mm long and 3 mm in diameter which fits onto the penetrometer. This rod is weighted with a 100 g load. The total weight of the assembly is 151.8 g including 4.3 for the cylindrical part and its support rod. The cup containing the sample of gum is placed in the thermostatic bath at 25±0.5° C. for at least 30 min. The measurement is taken according to the manufacturer's instructions. The values of the depth (V) in tenths of a millimeter and the time (t) in seconds to reach this depth are indicated on the apparatus. The penetrability is equal to 60 V/t expressed in tenths of a millimeter per minute

The non-reactive organopolysiloxane gums that may be used in accordance with the invention are used alone or as a mixture in an inorganic solvent. This solvent may be chosen from volatile silicones, octamethyl-cyclotetrasiloxane (D4), decamethylcylopentasiloxane (D5), polydimethylsiloxane (PDMS) oils, polyphenyl-methylsiloxane (PPMS) oils or mixtures thereof, so as to avoid the use of organic solvents that are harmful to the environment and to the health of the workers in tire manufacturing workshops.

Advantageously, the non-reactive organopolysiloxane is a linear non-reactive organopolysiloxane oil which is a linear homopolymer or copolymer. Preferably the linear non-reactive organopolysiloxane oil has a dynamic viscosity in the range from 0.65 to 100 000 mPa·s at 25° C. Examples that may be mentioned include linear organopolysiloxanes:
consisting along each chain:
i) of units of formula R⁵R⁶SiO_{2/2}, optionally combined with units of formula (R⁵)₂SiO_{2/2};
ii) of units of formula (R⁶)₂SiO_{2/2}, optionally combined with units of formula (R⁵)₂SiO_{2/2},
iii) of units of formula R⁵R⁶SiO_{2/2} and units of formula (R⁶)₂SiO_{2/2}, optionally combined with units of formula (R⁵)₂SiO_{2/2},
and blocked at each chain end with a unit of formula (R⁷)₃SiO_{1/2}, the R⁷ radicals of which, which may be identical or different, are chosen from R⁵ and R⁶ radicals;
where the R⁵ and R⁶ radicals, monovalent organic substituents of the various siloxyl units mentioned above, have the following definitions:
a) the R⁵ radicals, which may be identical to or different from one another, are chosen from:
1. linear C₁-C₆ or branched C₃-C₆ alkyl radicals, for instance methyl, ethyl, propyl, isopropyl, butyl, isobutyl, t-butyl, n pentyl or n-hexyl, and
2. C₃-C₈ cycloalkyl radicals for instance cyclopentyl or cyclohexyl,
b) the R⁶ radicals, which may be identical to or different from one another, are chosen from
1. C₆-C₁₀ aryl radicals for instance phenyl or naphthyl,
2. C₇-C₁₅ alkylaryl radicals for instance tolyl or xylyl, and
3. C₇-C₁₅ arylalkyl radicals for instance benzyl.

The reactive organopolysiloxane may be an oil or a gum, and preferably has a dynamic viscosity of between 50 and 600 000 mPa·s at 25° C. or a consistency of between 200 and 2000, expressed in tenths of a millimeter at 25° C.

Preferably, the reactive organopolysiloxane of the silicone-in-water emulsion E2 comprises the following siloxyl units:

M^{OH}=[(OH)(R²)₂SiO_{1/2}] and D=[R³R⁴SiO_{2/2}]
wherein:
R², R³ and R⁴ are identical or different radicals chosen from the group consisting of:
   linear or branched C₁-C₆ alkyl radicals, for instance methyl, ethyl, propyl, isopropyl, butyl, isobutyl, t-butyl, n-pentyl or n-hexyl;
   C₃-C₈ cycloalkyl radicals, for instance cyclopentyl or cyclohexyl;
   C₆-C₁₀ aryl radicals for instance phenyl or naphthyl, and
   C₇-C₁₅ alkylaryl radicals for instance tolyl or xylyl.

The silicone-in-water emulsion E2 also comprises an emulsifier D2. The nature of the emulsifier D2 will be readily determined by a person skilled in the art, the objective being to prepare a stable emulsion. Anionic, cationic, nonionic and zwitterionic surfactants may be used, alone or as a mixture.

It should be noted that the silicone-in-water emulsion E2 may also comprise protective colloids such as polyvinyl alcohol, as described in patent EP 0946240.

As anionic surfactants, mention may be made of the following surfactants:
the alkyl ester sulfonates of formula R^{a}—CH(SO₃M) COOR^{b}, where R^{a} represents a C₈-C₂₀, preferably C₁₀-C₁₆, alkyl radical, R^{b} represents a C₁-C₆, preferably C₁-C₃, alkyl radical and M represents an alkali metal (sodium, potassium, lithium) cation, a substituted or unsubstituted ammonium (methyl-, dimethyl-, trimethyl-, tetramethylammonium, dimethylpiperidinium) cation or a cation derived from an alkanolamine (monoethanolamine, diethanolamine, triethanolamine),
the alkyl sulfates of formula R^{c}OSO₃M, where R^{c} represents a C₁₀-C₂₄, preferably C₁₂-C₂₀, alkyl or hydroxyalkyl radical, M representing a hydrogen atom or a cation having the same definition as above, and also the ethoxylated (EO) and/or propoxylated (PO) derivatives thereof, preferably having from 1 to 20 EO units,
the alkylamide sulfates of formula R^{d}CONHR^{e}OSO₃M where R^{d} represents a C₂-C₂₂, preferably C₆-C₂₀, alkyl radical, R^{e} represents a C₂-C₃ alkyl radical, M representing a hydrogen atom or a cation having the same definition as above, and also the ethoxylated (EO) and/or propoxylated (PO) derivatives thereof, preferably having from 1 to 20 EO units,
the salts of saturated or unsaturated C₈-C₂₄, preferably C₁₄-C₂₀, fatty acids, C₉-C₂₀ alkylbenzenesulfonates, and also the the ethoxylated (EO) and/or propoxylated (PO) derivatives thereof, preferably having from 1 to 20 EO units,
C₉-C₂₀ alkylbenzenesulfonates, primary or secondary C₈-C₂₂ alkyl sulfonates, alkylglycerol sulfonates, the sulfonated polycarboxylic acids described in GB-A-1 082 179, paraffin sulfonates, N-acyl-N-alkyl taurates, monoalkyl and dialkyl phosphates, alkyl isethionates, alkyl succinamates, alkyl sulfosuccinates, sulfosuccinate monoesters or diesters, N-acyl sarcosinates, alkyl glycoside sulfates, polyethoxycarboxylates, the cation being an alkali metal (sodium, potassium or lithium), a substituted or unsubstituted ammonium residue (methyl-, dimethyl-, trimethyl-, tetramethylammonium, dimethylpiperidinium) or an alkanolamine derivative (monoethanolamine, diethanolamine or triethanolamine).

As nonionic surfactants, mention may be made of poly(alkylene oxide) alkyl or aryl ethers, polyoxyethylene sorbitan hexastearate, polyoxyethylene sorbitan oleate and poly(ethylene oxide) cetyl stearyl ethers. As poly(alkylene oxide) aryl ethers, mention may be made of polyoxyethylene alkylphenols. As poly(alkylene oxide) alkyl ethers, mention may be made of polyethylene glycol isodecyl ether and polyethylene glycol trimethylnonyl ether containing from 3 to 15 ethylene oxide units per molecule.

As examples of surfactants, mention may also be made of: ionic, nonionic or amphoteric fluorinated surfactants and mixtures thereof, for example:
perfluoroalkyls,
perfluorobetaines,
ethoxylated polyfluoroalcohols,
ammonium polyfluoroalkyls,
surfactants, the hydrophilic part of which contains one or more saccharide units bearing from five to six carbon atoms and the hydrophobic part of which contains a unit of formula R^{f}(CH₂)ₙ—, in which n=2 to 20 and R^{f} represents a perfluoroalkyl unit of formula CₘF₂ₘ₊₁, in which m=1 to 10; and
polyelectrolytes having fatty perfluoroalkyl side groups.

The term “fluorinated surfactant” is understood to mean, as is perfectly known per se, a compound formed of an aliphatic perfluorocarbon part, comprising at least three carbon atoms, and an ionic, nonionic or amphoteric hydrophilic part. The perfluorocarbon part of at least three carbon atoms may represent either all or only a fraction of the fluorocarbon part of the molecule. There are a large number of references in the literature as regards this type of compound. A person skilled in the art may notably refer to the following references:
FR-A-2 149 519, WO-A-94 21 233, U.S. Pat. No. 3,194,767, the book Fluorinated Surfactants, Erik Kissa, published by Marcel Dekker Inc. (1994) Chapter 4, notably Tables 4.1 and 4.4.

Mention may be made in particular of the products sold by the company DuPont under the name Zonyl®, for example FSO, FSN-100, FS-300, FSD, and also the fluorinated surfactants of the name Forafac® distributed by the company DuPont and the products sold under the name Fluorad® by the company 3M.

Among these surfactants, mention may be made in particular of anionic, cationic, nonionic and amphoteric perfluoroalkyl compounds, and among them, more particularly, the surfactants of the Zonyl® class sold by DuPont, sold by DuPont under the names Zonyl® FSA, Zonyl® FSO, Zonyl® FSC and Zonyl® FSK, respectively.

The following may also be specified with respect thereto:
Zonyl® FSO 100: CAS 65545-80-4, (nonionic) 99% to 100%, the remainder being 1,4-dioxane,
Zonyl® FSN: CAS 65545-80-4, 99% to 100%, the remainder being sodium acetate and 1,4-dioxane,
Zonyl® FS-300: CAS 65545-80-4, 40%, the remainder being 1,4-dioxane (<0.1%) and water,
Zonyl® FSD: CAS 70983-60-7 30%, (cationic), the remainder being hexylene glycol (10%), sodium chloride (3%) and water (57%).

Mention may also be made of:
perfluoroalkyl betaines (amphoteric) such as the product sold by DuPont under the name Forafac® 1157, ethoxylated polyfluoroalcohols (nonionic), such as the product sold by DuPont under the name Forafac 1110 D, polyfluoroalkylammonium salts (cationic), such as the product sold by DuPont under the name Forafac 1179,
surfactants in which the hydrophilic part contains one or more saccharide units containing from 5 to 6 carbon atoms (units derived from sugars such as fructose, glucose, mannose, galactose, talose, gulose, allose, altose, idose, arabinose, xylose, lyxose and/or ribose) and in which the hydrophobic part contains a unit of formula R^{F}(CH₂)ₙ, where n may range from 2 to 20, preferably from 2 to 10, and R^{F} represents a perfluoroalkyl unit of formula CₘF₂ₘ₊₁ with m possibly ranging from 1 to 10, preferably from 4 to 8, chosen from those having the characteristics defined above; mention may be made of the monoesters of perfluoroalkylated fatty acids and of sugars such as sucrose, it being possible for the monoester function to be represented by the formula R^{F}(CH₂)ₙC(O), where n may range from 2 to 10 and R^{F} represents a perfluoroalkyl unit of formula CₘF₂ₘ₊₁ with m possibly ranging from 4 to 8, described in the Journal of the American Oil Chemists' Society (JAOCS), Vol. 69, No. 1, (January 1992) and chosen from those having the characteristics defined above; and
polyelectrolytes having fatty perfluoroalkyl side groups such as polyacrylates having R^{F}(CH₂)ₙ groups where n may range from 2 to 20, preferably from 2 to 10 and R^{F} represents a perfluoroalkyl unit of formula CₘF₂ₘ₊₁ with m possibly ranging from 1 to 10, preferably from 4 to 8, chosen from those having the characteristics defined above; mention may be made of the polyacrylates containing —CH₂C₇F₁₅ groups described in J. Chim. Phys. (1996) 93, 887-898 and chosen from those having the characteristics defined above.

The amount of emulsifier D2 depends on the type of each of the constituents present and on the very nature of the emulsifier used. As a general rule, the emulsion comprises from 0.1% to 10% by weight of emulsifier relative to the total weight of the emulsion.

Moreover, in a conventional and nonlimiting manner, use may also be made, in the emulsions, of additives F2 such as film-forming polymers, biocides, rheology modifiers, coalescers, dispersants, acidifying agents, neutralizing agents, bases and/or thickeners, alone or as a mixture.

The concentrations of such adjuvants are known to those skilled in the art.

According to another embodiment, the silicone-in-water antifoam emulsion EA is characterized in that the silicone antifoam AS is obtained by polycondensation chemistry.

Said polycondensation chemistry is well known to those skilled in the art. Without being limiting, mention may be made for example of documents EP 0163541 and EP 2794760.

According to another embodiment, the silicone-in-water antifoam emulsion EA, is characterized in that the silicone antifoam AS is obtained by polyaddition chemistry.

Said polyaddition or hydrosilylation chemistry is well known to those skilled in the art. Without being limiting, mention may be made for example of documents EP0434060, U.S. Pat. No. 8,053,480, WO2018224131 and WO2021167728.

According to another embodiment, the silicone-in-water antifoam emulsion EA, is characterized in that the silicone antifoam AS is obtained by radical chemistry.

Said radical chemistry is well known to those skilled in the art. Without being limiting, mention may be made for example of document WO2021126195.

According to another embodiment, the silicone-in-water antifoam emulsion EA, is characterized in that the silicone antifoam AS is obtained by mixing various silicone antifoams AS.

The mineral filler C of the silicone antifoam AS is a compound chosen from the group comprising silicas, preferably fumed silicas and/or precipitated silicas and/or colloidal silicas, diatomaceous earths, ground quartz, calcium carbonate, hydrated alumina, magnesium hydroxide, carbon black, titanium dioxide, aluminum oxide, vermiculite, zinc oxide, mica, talc, iron oxide, barium sulfate, slaked lime, and mixtures thereof. The mineral filler C of the silicone antifoam AS is preferentially silica.

It may be treated or untreated precipitated silica or fumed silica. The precipitated silica is preferably made hydrophobic beforehand by conventional treatment with one or more organosilicon compounds. It may be incorporated untreated and then treated (rendered hydrophobic) in situ by one or more organosilicon compounds. Among such compounds are methylpolysiloxanes, such as hexamethyldisiloxane and octamethylcyclotetrasiloxane, methylpolysilazanes, such as hexamethyldisilazane and hexamethylcyclotrisilazane, chlorosilanes, such as dimethyldichlorosilane, trimethylchlorosilane, methyl-vinyldichlorosilane and dimethylvinylchlorosilane, and alkoxysilanes, such as dimethyldimethoxysilane. During this treatment, the silicas may increase their initial weight by up to 20%. The fumed silica may be used untreated. If required, it may, however, be treated like the precipitated silica.

The mineral fillers C generally have a specific surface area, measured according to the BET methods, of at least 10 m²/g, notably of between 20 and 300 m²/g.

A mixture of fillers C may be used.

The content of mineral filler C is generally between 0.1% and 10% by weight of the silicone antifoam AS, preferably between 0.5% and 10% by weight of the silicone antifoam AS.

The silicone antifoam AS or the silicone-in-water antifoam emulsion EA1 may optionally contain polyether silicones to improve the antifoam in properties. The latter are well known to those skilled in the art. By way of illustration which is in no way limiting, reference may be made to documents WO2020228212, EP3423165, EP2563491 and EP2563491.

According to another embodiment, the silicone-in-water antifoam emulsion EA is characterized in that it comprises a silicone-in-water antifoam emulsion EA1 with a water content of less than 65% and a silicone-in-water emulsion E2 with a water content of less than 65%.

According to another embodiment, the silicone-in-water antifoam emulsion EA is characterized in that the particle size distribution of the dispersed silicone phases is of bimodal type with a percentage of coarse particles/percentage of fine particles ratio of between 98/2 and 60/40, the percentage of coarse particles being calculated in the following manner: (weight of silicone antifoam AS+weight of organopolysiloxane B1+weight of emulsifiers D1) of the antifoam emulsion EA1/sum of ((weight of silicone antifoam AS+weight of organopolysiloxane B1+weight of emulsifiers D1) of the antifoam emulsion EA1 and of weight of solids of the emulsion E2) and the percentage of fine particles being the balance to 100%.

Preferably, percentage of coarse particles/percentage of fine particles ratio of the antifoam emulsion EA is between 98/2 and 70/30.

According to another embodiment, the silicone-in-water antifoam emulsion EA is characterized in that its comprises, per 100 parts by weight of antifoam emulsion EA:
from 70 to 98 parts by weight of a silicone-in-water antifoam emulsion EA1 with a volume mean diameter d_{EA1} of greater than or equal to 6 μm comprising:
a) from 15 to 55 parts by weight of at least one silicone antifoam AS comprising from 0.1 to 10 parts by weight of at least one mineral filler C,
b) from 0 to 25 parts by weight of at least one organopolysiloxane B1,
c) from 0.1 to 12 parts by weight of at least one emulsifier D1,
d) from 0.01 to 5 parts by weight of at least one additive F1,
e) from 3 to 65 parts by weight of water W1, and
   from 2 to 30 parts by weight of at least a second silicone-in-water emulsion E2 with a volume mean diameter d_{E2} of less than d_{EA1}.

The organopolysiloxane B1 may be identical to or different from B2 and may be reactive or non-reactive as described for B2.

The emulsifier D1 may be identical to or different from D2. It may be a protective colloid such as polyvinyl alcohols or nonionic, anionic or cationic surfactants, alone or as a mixture.

The additive F1 may be identical to or different from F2.

Another subject of the present invention relates to a process for preparing a silicone-in-water antifoam emulsion EA, characterized in that it comprises the following essential steps:
a) dispersing, with stirring and at a temperature above 50° C. and below 75° C., at least one silicone antifoam AS, optionally at least one organopolysiloxane B1, at least one emulsifier D1 and a portion of the water, until the mixture has been homogenized,
b) cooling, with stirring, the mixture obtained at the end of step a) down to a temperature below or equal to 30° C. and adding the second portion of water, then the additive F1 and stirring until the mixture has been homogenized in order to obtain EA1,
c) adding, to EA1, the silicone-in-water emulsion E2 and stirring until the silicone-in-water antifoam emulsion EA has been completely homogenized.

More particularly, the invention relates to a process for inhibiting foam formation by adding a silicone-in-water antifoam emulsion EA, to the liquid surface.

Other advantages and features of the present invention will become apparent on reading the following examples given by way of illustration that is in no way limiting.

### EXAMPLES

In the examples below, various silicone antifoams AS, polydimethylsiloxane silicone oils B1, silicone-in-water emulsions E2 and emulsifiers D1 were used to prepare silicone-in-water antifoam emulsions EA according to the invention. Unless otherwise mentioned, throughout the present document, the % are expressed as % by weight.

### Raw Materials Used

Various commercial antifoams AS with a silica content C of between 0.5% and 10% were used:
Silcolapse™ 825, sold by Elkem Silicones, is a silicone antifoam AS obtained from polycondensation chemistry as described in EP0163541;
Silcolapse® 120, sold by Elkem Silicones, is a silicone antifoam AS as described in U.S. Pat. No. 3,383,327;
Silcolapse® 490, sold by Elkem Silicones, is a silicone antifoam AS obtained from polycondensation chemistry as described in EP0163541.

Bluesil™ FLD 47V350, sold by Elkem Silicones, is a non-reactive polydimethylsiloxane silicone oil B1 with a viscosity ˜350 mPa·s.

Bluesil™ FLD 48V135000, sold by Elkem Silicones, is a reactive (α,ω-dihydroxy) polydimethylsiloxane silicone oil B1 with a viscosity ˜135 000 mPa·s.

Various commercial emulsions E2 were used:
Bluesil™ Emul 872, sold by Elkem Silicones, is an emulsion E2 of 47V350 non-reactive polydimethylsiloxane silicone oil B2 containing ˜61% solids and having a volume mean diameter D[4,3] of 0.16 μm;
Bluesil Emul 284, from Elkem Silicones, is an emulsion E2 of 48V135000 reactive (α,ω-dihydroxy) polydimethylsiloxane silicone oil B2 containing ˜51% solids and having a volume mean diameter D[4,3] of 0.26 μm.

Radiasurf 7145, sold by Oleon, is an emulsifier D1: Sorbitan monostearate.

Myrj S40, sold by Croda, is an emulsifier D1: PEG-40 stearate.

Rhodasurf ROX, sold by Solvay, is an emulsifier D2: ethoxylated branched alcohol.

Proxel GXL, sold by Lonza, is an additive F1: solution containing 20% of 1,2-benzisothiazolin-3-one.

### Characterization of the Emulsions—Measurement Methods:

The solids content is expressed as % of residue and is measured using a halogen moisture analyzer (1 g—105° C.—60 min).

The viscosity of the emulsion is measured at the start and after 1 month at 40° C. using a Brookfield (A4V20) viscometer.

The particle size distribution PSD is measured with a Mastersizer 3000 Laser Granulometer from Malvern. D[4,3] corresponds to the volume mean diameter and is expressed in μm.

The ease of use of the emulsions is estimated by filtration through a 250 μm nylon screen.

In order to estimate the dispersibility of the emulsion, a drop of emulsion is dropped from a pipette into a cylindrical tube 4.5 cm high and 1.4 cm in diameter that is filled with 3 ml of deionized water. The number of complete inversions needed for total dispersibility is quantified. The emulsion is considered to be dispersible if the number of complete inversions is less than 10 and preferably less than 5.

Regarding the storage stability, it is verified visually every two months. The number of months at the end of which phase separation is observed is recorded.

The antifoaming properties are verified using a recirculation test. 800 ml of detergent solution (aqueous solution containing 3 g/l of sodium dodecyl benzene sulfonate and C12-C18 fatty alcohol ethoxylated on average 7 times) are pumped in recirculation through a specimen of 2 liters at a flow rate of 200 l/h at 60° C. As soon as the foam level reaches the graduation H1 in ml, 50 mg of antifoaming emulsion are injected, and the foam level is monitored over time. First the foam level drops, and the reading of its low point (H2 in ml) makes it possible to calculate the “shock effect” (1−(H2/H1)), expressed as a percentage.

Compositions and characteristics of the emulsions EA obtained from a single silicone antifoam AS.

TABLE 1

| | | Example 1 |
|---|---|---|
| Composition of | | according |
| Antifoam Emulsion | Comparative | to the |
| EA (g) | Example 1 | invention |
| Antifoam Emulsion EA1 | | |
| Silcolapse 825 (silicone | 155 | 154 |
| antifoam AS) | | |
| Bluesil 47V350 (silicone oil B1) | 210 | 110 |
| Radiasurf 7145 (emulsifier D1) | 66.9 | 49.5 |
| Myrj S40 (emulsifier D1) | 23 | 16.6 |
| Water W1 | 442 | 394 |
| Proxel GXL (additive F1) | 1.4 | 1.4 |
| Bluesil Emul 872 (E2) | 0 | 176 |
| Total weight EA (g) | 898.3 | 901.5 |
| % coarse particles | 100 | 75 |
| % fine particles | | 25 |
| Characteristics | | |
| PSD type | monomodal | bimodal |
| D[4,3] μm | 90 | 54 |
| Initial viscosity A4V20 (mPa · s) | >10 000 | 270 |
| Solids content % | 51 | 48 |
| Filtration through 250 μm screen | no | yes |
| Water dispersibility (number of | >20 | 1 |
| inversions) | | |
| Viscosity after 1 month at 40° C. | >10 000 | 1410 |
| A4V20 (mPa · s) | | |
| Phase separation after x months | 4 months | >12 months |

Example 1 according to the invention: A glass container equipped with an anchor stirrer is charged with 154 g of Silcolapse 825 AS, 110 g of Bluesil 47V350 B1, 49.5 g of Radiasurf 7145 D1, 16.6 g of Myrj S40 D1 and 65.1 g of deionized water W1 (first portion). Stirring is carried out at 60 rpm for 45 min while heating to reach a temperature of 65° C. so as to melt the emulsifiers and homogenize the mixture. The stirring is then increased to 150 rpm for 20 minutes before cooling the mixture to 30° C., at which temperature 329 g of deionized water W1 (second portion) are added over one hour at a speed of 10 rpm while continuing the cooling down to room temperature. The stirring speed is increased to 50 rpm for 25 minutes. Then 176 g of Bluesil Emul 872 emulsion E2 are added over 15 minutes. Lastly, 1.4 g of Proxel GXL F1 are added and the stirring is continued for 15 minutes.

The concentrated silicone-in-water antifoam emulsion obtained is a white emulsion having a bimodal particle size distribution, a volume mean diameter [D(4,3)] of 54 μm, a solids content of 48% and a viscosity of 270 mPa·s, namely ˜37 times lower than comparative example 1 at a comparable solids content.

Unlike comparative example 1, the emulsion is more filtered without difficulty through a 250 μm screen and it is dispersible. Its viscosity after one month at 40° C. is much less than 3500 mPa·s.

Comparative example 1: The procedure of example 1 was followed except for the addition of Bluesil Emul 872 E2 and with the amounts of each ingredient mentioned in table 1. In the absence of Bluesil Emul 872 emulsion E2, the emulsion obtained has a monomodal particle size distribution, the volume mean diameter [D(4,3)] is ˜90 μm, the viscosity is greater than 10 000 mPa·s for a comparable solids content to example 1 according to the invention. Unlike example 1 according to the invention, the emulsion cannot be filtered through a 250 μm screen, its dispersibility is poor and phase separation is observed after 4 months.

Compositions and characteristics of the emulsions EA obtained from a mixture of 2 silicone antifoams AS.

TABLE 2

| | | Example 2 | Example 3 | Example 4 | Example 5 |
|---|---|---|---|---|---|
| Composition of | | according | according | according | according |
| Antifoam Emulsion | Comparative | to the | to the | to the | to the |
| EA (g) | Example 2 | invention | invention | invention | invention |
| Antifoam Emulsion | | | | | |
| EA1 | | | | | |
| Silcolapse 825 | 153 | 155 | 155 | 154 | 156 |
| (silicone | | | | | |
| antifoam AS) | | | | | |
| Silcolapse 120 | 113 | 117 | 117 | 120 | 127 |
| (silicone | | | | | |
| antifoam AS) | | | | | |
| Bluesil 47V350 | 85.9 | 77.4 | 51.8 | 35 | 0 |
| (silicone oil B1) | | | | | |
| Radiasurf 7145 | 66 | 65 | 60.1 | 57.6 | 52.3 |
| (emulsifier D1) | | | | | |
| Myrj S40 | 22 | 21.8 | 20.7 | 19.1 | 17.3 |
| (emulsifier D1) | | | | | |
| Water W1 | 454 | 440 | 412 | 391 | 376 |
| Proxel GXL | 1.4 | 1.4 | 1.4 | 1.4 | 1.4 |
| (additive F1) | | | | | |
| Bluesil Emul 872 | 0 | 25.1 | 88.3 | 131 | 174 |
| (E2) | | | | | |
| Total weight EA | 895.3 | 902.7 | 906.3 | 909.1 | 904 |
| (g) | | | | | |
| % coarse | 100 | 97 | 88 | 83 | 77 |
| particles | | | | | |
| % fine particles | 0 | 3 | 12 | 17 | 23 |
| Characteristics | | | | | |
| PSD type | monomodal | bimodal | bimodal | bimodal | bimodal |
| D[4,3] μm | 69 | 34 | 31 | 23 | 13 |
| Initial viscosity | >10 000 | 5350 | 2670 | 1460 | 1050 |
| A4V20 (mPa · s) | | | | | |
| Solids content % | 49.3 | 49.6 | 50.2 | 50.9 | 49.6 |
| Filtration | no | yes | yes | yes | yes |
| through 250 μm | | | | | |
| screen | | | | | |
| Water | >20 | 5 | 4 | 3 | 3 |
| dispersibility | | | | | |
| (number of | | | | | |
| inversions) | | | | | |
| Viscosity after 1 | >10 000 | 690 | 430 | 2330 | 2180 |
| month at 40° C. | | | | | |
| A4V20 (mPa · s) | | | | | |
| Phase separation | 6 months | >12 months | >12 months | >12 months | >12 months |
| after x months | | | | | |
| Antifoaming | 89% | 90% | 88% | 89% | 91% |
| property: shock | | | | | |
| effect % | | | | | |

Examples 2 to 5 according to the invention: The procedure of example 1 was followed with the amounts of each ingredient mentioned in table 2. A mixture of 2 silicone antifoams AS is used instead of just one. White emotions are obtained having a bimodal particle size distribution, a volume mean diameter [D(4,3)] between 34 and 13 μm, a viscosity of less than 6000 mPa·s for a solids content close to 50%, namely a viscosity 2 to 10 times lower than comparative example 2 at a comparable solids content. All the emulsions can be filtered through a 250 μm screen, have a good dispersibility, namely less than or equal to 5 inversions, and a viscosity after one month at 40° C. of less than 6000 mPa·s. No phase separation is observed after 12 months of storage, while exhibiting good antifoaming properties: the shock effect measured is greater than 89%.

Comparative example 2: The procedure of examples 2 to 5 was followed except for the addition of emulsion E2 and with the amounts of each ingredient mentioned in table 2. The emulsion obtained is a very viscous white paste having a monomodal particle size distribution. The volume mean diameter is ˜70 μm, the viscosity is greater than 10 000 mPa·s for a comparable solids content to examples 2 to 5 according to the invention. Unlike examples 2 to 5 according to the invention, the emulsion cannot be filtered through a 250 μm screen, its dispersibility is poor (>20 inversions) and phase separation is observed after 6 months.

Compositions and characteristics of the emulsions EA obtained from a emulsions E2 of different volume mean diameter.

TABLE 3

| | | Example 6 | Example 7 | Example 8 | Example 9 |
|---|---|---|---|---|---|
| Composition of | | according | according | according | according |
| Antifoam Emulsion | Comparative | to the | to the | to the | to the |
| EA (g) | Example 3 | invention | invention | invention | invention |
| Antifoam Emulsion | | | | | |
| EA1 | | | | | |
| Silcolapse 490 | 199 | 194 | 195 | 196 | 194 |
| (silicone antifoam | | | | | |
| AS) | | | | | |
| Bluesil 48V135000 | 95.3 | 67.9 | 66.6 | 67 | 38.4 |
| (silicone oil B1) | | | | | |
| Radiasurf 7145 | 32.3 | 29 | 29.3 | 29.1 | 26.2 |
| (emulsifier D1) | | | | | |
| Myrj S40 | 10.6 | 9.7 | 9.7 | 9.7 | 8.8 |
| (emulsifier D1) | | | | | |
| Water W1 | 176 | 140 | 145 | 137 | 107 |
| Proxel GXL | 0.8 | 0.8 | 0.8 | 0.8 | 0.8 |
| (additive F1) | | | | | |
| Bluesil Emul 284 | | | | 71.4 | 127 |
| (E2) | | | | | |
| E2 D[4,3] = 3.5 μm | | | 62.3 | | |
| E2 D[4,3] = 5.5 μm | | 68.2 | | | |
| Total weight EA (g) | 514 | 509.6 | 508.7 | 511 | 502.2 |
| % coarse particles | 100 | 88 | 90 | 87 | 78 |
| % fine particles | 0 | 12 | 10 | 13 | 22 |
| Characteristics | | | | | |
| PSD type | monomodal | bimodal | bimodal | bimodal | bimodal |
| D[4,3] μm | 18 | 12.1 | 4.8 | 5.9 | 4.5 |
| Initial viscosity | 9950 | 1330 | 2250 | 3070 | 4300 |
| A4V20 (mPa · s) | | | | | |
| Solids content % | 66.3 | 66.4 | 66.4 | 66 | 66.2 |
| Filtration through | no | yes | yes | yes | Yes |
| 250 μm screen | | | | | |
| Water dispersibility | 9 | 2 | 2 | 3 | 3 |
| Viscosity after 1 | >10 000 | 2000 | 3320 | 4230 | 5150 |
| month at 40° C. A4V20 | | | | | |
| (mPa · s) | | | | | |

### Preparation of the Emulsions E2:

Bluesil Emul 284 emulsion: E2 D[4,3]=3.5 μm A glass container equipped with an anchor stirrer is charged with 195 g of Bluesil FLD 48V135000 oil B2, 16.1 g of Rhodasurf ROX D2 and 6.5 g of deionized water W2 (first portion). Stirring is carried out at 30 rpm for 20 minutes, then 134 g of deionized water W2 (second portion) is added over 15 minutes. When all the water has been incorporated, the stirring is maintained for 15 min at 100 rpm, and 0.5 g of Proxel GXL F2 is added. The silicone oil-in-water emulsion obtained is a white emulsion having a volume mean diameter [D(4,3)] of 3.5 μm and a solids content of 58.5%.

Bluesil Emul 284 emulsion: E2 D[4,3]=5.5 μm

A glass container equipped with an anchor stirrer is charged with 177 g of Bluesil FLD 48V135000 oil B2, 9.6 g of Rhodasurf ROX D2 and 9.0 g of deionized water W2 (first portion). Stirring is carried out at 40 rpm for 10 minutes, then 157 g of deionized water W2 (second portion) is added over 20 minutes. When all the water has been incorporated, the stirring is maintained for 15 min at 100 rpm, and 0.5 g of Proxel GXL F2 is added. The silicone oil-in-water emulsion obtained is a white emulsion having a volume mean diameter [D(4,3)] of 5.5 μm and a solids content of 51.6%.

Examples 6 to 9 according to the invention: The procedure of example 1 was followed with the amounts of each ingredient mentioned in table 3. Emulsions E2 having different volume mean diameters are used. White emulsions are obtained having a bimodal particle size distribution, a volume mean diameter [D(4,3)] of between 12.3 and 4.5 μm, a viscosity of less than 6000 mPa·s for a solids content close to 66%, namely a viscosity 2 to 7 times lower than comparative example 3 at a comparable solids content. All the emulsions can be filtered through a 250 μm screen, have a good dispersibility, namely less than or equal to 5 inversions, and a viscosity after one month at 40° C. of less than 6000 mPa·s.

Comparative example 3: The procedure of examples 6 to 9 was followed except for the addition of emulsion E2 and with the amounts of each ingredient mentioned in table 3. The emulsion obtained is a viscous white paste having a monomodal particle size distribution. The volume mean diameter is ˜70 μm, the viscosity is 9950 mPa·s for a comparable solids content to examples 6 to 9 according to the invention. Unlike examples 6 to 9 according to the invention, the emulsion cannot be filtered through a 250 μm screen, its dispersibility is poor (9 inversions).

1. A silicone-in-water antifoam emulsion EA comprising:
at least a first silicone-in-water antifoam emulsion EA1 with a volume mean diameter d_{EA1} of greater than or equal to about 6 μm comprising:
a) at least one silicone antifoam AS comprising from about 0.1% to about 10% by weight of at least one mineral filler C,
b) optionally at least one organopolysiloxane B1,
c) at least one emulsifier D1,
d) at least one additive F1,
e) water W1, and
at least a second silicone-in-water emulsion E2 with a volume mean diameter d_{E2} of less than d_{EA1} and wherein the silicone-in-water antifoam emulsion EA comprises a water content of less than about 65% by weight.

2. The silicone-in-water antifoam emulsion EA as claimed in claim 1, wherein the emulsion EA has a viscosity of less than about 6000 mPa·s.

3. The silicone-in-water antifoam emulsion EA as claimed in claim 1, wherein the content of the silicone-in-water emulsion E2 is between about 2% and about 30% relative to the total weight of the silicone-in-water antifoam emulsion EA.

4. The silicone-in-water antifoam emulsion EA as claimed in claim 1, wherein the silicone-in-water emulsion E2 is an emulsion with a volume mean diameter d_{E2} of between about 0.01 μm and about 6 μm.

5. The silicone-in-water antifoam emulsion EA as claimed in claim 1, wherein the silicone-in-water emulsion E2 is a silicone-in-water emulsion with a silicone concentration of greater than or equal to about 35% by weight of the total weight of E2.

6. The silicone-in-water antifoam emulsion EA as claimed in claim 1, wherein the silicone-in-water emulsion E2 comprises
from about 35 parts to about 80 parts by weight of at least one organopolysiloxane B2,
from about 0.1 parts to about 10 parts by weight of at least one emulsifier D2,
from about 0 parts to about 5 parts by weight of at least one additive F2 and
from about 5 parts to about 65 parts by weight of water W2 per 100 parts by weight of the sum of the constituents B2, D2, F2 and W2.

7. The silicone-in-water antifoam emulsion EA as claimed in claim 1, wherein the silicone antifoam AS is obtained by polycondensation chemistry.

8. The silicone-in-water antifoam emulsion EA as claimed in claim 1, wherein the silicone antifoam AS is obtained by polyaddition chemistry.

9. The silicone-in-water antifoam emulsion EA as claimed in claim 1, wherein the silicone antifoam AS is obtained by radical chemistry.

10. The silicone-in-water antifoam emulsion EA as claimed in claim 1, wherein the silicone antifoam AS is obtained by mixing various silicone antifoams AS.

11. The silicone-in-water antifoam emulsion EA as claimed in claim 1, wherein the emulsion EA comprises a silicone-in-water antifoam emulsion EA1 with a water content of less than about 65% and a silicone-in-water emulsion E2 with a water content of less than about 65%.

12. The silicone-in-water antifoam emulsion EA as claimed in claim 1, wherein the particle size distribution of the dispersed oily phases is of bimodal type with a percentage of coarse particles/percentage of fine particles ratio of between about 98/2 and about 60/40, the percentage of coarse particles being calculated in the following manner: (weight of silicone antifoam AS+weight of organopolysiloxane B1+weight of emulsifiers D1) of the antifoam emulsion EA1/sum of ((weight of silicone antifoam AS+weight of organopolysiloxane B1+weight of emulsifiers D1) of the antifoam emulsion EA1 and of weight of the emulsion E2) and the percentage of fine particles being the balance to 100%.

13. The silicone-in-water antifoam emulsion EA as claimed in claim 1, wherein the emulsion EA comprises, per 100 parts by weight of antifoam emulsion EA:
from about 70 parts to about 98 parts by weight of a silicone-in-water antifoam emulsion EA1 with a volume mean diameter d_{EA1} of greater than or equal to about 6 μm comprising:
a) from about 15 parts to about 55 parts by weight of at least one silicone antifoam AS comprising from about 0.1 to about 10 parts by weight of at least one mineral filler C,
b) from about 0 parts to about 25 parts by weight of at least one organopolysiloxane B1,
c) from about 0.1 parts to about 12 parts by weight of at least one emulsifier D1
d) from about 0.01 parts to about 5 parts by weight of at least one additive F1
e) from about 3 parts to about 65 parts by weight of water W1, and
from about 2 parts to about 30 parts by weight of at least a second silicone-in-water emulsion E2 with a volume mean diameter d_{E2} of less than d_{EA1}.

14. A process for preparing a silicone-in-water antifoam emulsion EA as claimed in claim 1, wherein the process comprises the following steps:
a) dispersing, with stirring and at a temperature above about 50° C. and below about 75° C., at least one silicone antifoam AS, optionally at least one organopolysiloxane B1, at least one emulsifier D1 and a portion of the water, until the mixture has been homogenized,
b) cooling, with stirring, the mixture obtained at the end of step a) down to a temperature below or equal to about 30° C. and adding the second portion of water, then the additive F1 and stirring until the mixture has been homogenized in order to obtain EA1,
c) adding, to EA1, the silicone-in-water emulsion E2 and stirring until the silicone-in-water antifoam emulsion EA has been homogenized.

15. A process of inhibiting foam formation by adding a silicone-in-water antifoam emulsion EA to a liquid surface, wherein the silicone-in-water antifoam emulsion EA, is obtained by the process of claim 14.

16. A process of inhibiting foam formation, the process comprising adding a silicone-in-water antifoam emulsion EA to a liquid surface, wherein the silicone-in-water antifoam emulsion EA is the emulsion EA of claim 1.
